(19) United States
(12) Patent Application Publication
(10) Pub. No.: US 2004/0123520 A1
(43) Pub. Date: Jul. 1, 2004

(54) Device and method of moisture retention and fertilization

(76) Inventors: Phillip A. McCrory, Madison, AL (US); Blair K. Blacker, Madison, AL (US)

Correspondence Address: LANIER FORD SHAVER & PAYNE, P O BOX 2087, HUNTSVILLE, AL, 35804, US

(21) Appl. No.: 10/331,201

(22) Filed: Dec. 30, 2002

(51) Int. Cl. A01G 7/00

(52) U.S. Cl. 47/9

(57) ABSTRACT

An apparatus for the retention of moisture at or near the root system of a plant or group of plants is provided. The apparatus is a mat or hanging plant pot liner comprised of any single composition or combination of a natural fiber, human hair and/or animal hair. Such apparatus is capable of complete biodegradation over time and may serve as a time-release fertilizer for a plant or group of plants

### BACKGROUND OF THE INVENTION

This invention generally relates to an apparatus for the retention of moisture and for both active and passive fertilization in horticulture. In particular, the present invention relates to an apparatus for ensuring a moisture rich environment for the roots of various plants and grasses that may also serve as a nutrient source during its own biodegradation. More particularly, the present invention relates to an apparatus and its method of use for providing and maintaining a constant source of moisture for various plants, trees, bushes and grasses while simultaneously serving as both an active and passive fertilizer. In such context, the present invention is comprised primarily of any individual component or combination of human hair, animal hair and/or natural biodegradable fiber, including, but not limited to, coconut, seaweed, kelp, cotton and peat moss.

Those involved in growing plants for food, decoration or pleasure have long been aware that plants, trees, bushes and grasses require three main ingredients to maintain their health and to promote continued growth. These are sunlight, water and fertile soil. While artificial lights may be used for indoor gardening, they are generally ineffective and difficult to utilize outdoors. Gardeners, horticulturists and farmers have been actively manipulating the latter two requirements for centuries.

Farmers, for instance, have manipulated the delivery of water to their crops in an effort to ensure an adequate supply of water by establishing reservoirs, creating irrigation canals or, more recently, through the use of modern irrigation systems. They have also learned to enrich their soil by rotating crops and adding amendments thereto. Gardeners, hobbyists and homeowners have slowly begun adopting similar systems that allow for the delivery of a continuous flow of water to plants through the use of drip lines and soaking hoses. More often than in the past, they actively use fertilizers and other soil amendments in an effort to improve the growth of their plants, including trees, bushes and lawns.

As these methods are often not functionally effective or practical for use with indoor or decorative plants or with a large number of plants spread over a number of varied locations around the home, many homeowners must provide for regular and even daily care of their lawns, plants and trees. It is, therefore, desirable to provide an all-natural biodegradable device for the retention and maintenance of moisture at or near the root system of a plant that can additionally serves as a source of nutrients for such plant during its biodegradation. The present invention provides such an apparatus.

### SUMMARY OF THE INVENTION

The present invention recognizes and addresses various of the foregoing limitations and drawbacks, and others, concerning various horticultural devices for aiding in the retention of moisture at or near the root systems of individual or groups of plants, tress, plants or grasses while simultaneously acting as a fertilization source via its own biodegradation.

It is, therefor, a principle object of the present invention to provide an apparatus for retaining moisture at or near the root system of a plant or group of plants. More particularly, it is an object of the present invention to provide an apparatus for retaining moisture at or near the root system of a plant or group of plants that is comprised solely of natural materials. In such context, it is still a more particular object of the present invention to provide such an apparatus comprised of human hair.

Alternatively, in such context, it is a principle object of this invention to provide such an apparatus comprised of animal hair. It is a further object of the present invention to provide an apparatus for the retention of moisture at or near the root system of a plant or group of plants comprised of a combination of human and animal hairs. In such context, it is an object of the present invention to provide such an apparatus further comprising a natural fiber. Still further in such context, it is an object of the present invention to provide such an apparatus capable of serving such plant or group of plants as a nutrient source during its complete biodegradation.

Additional objects and advantages of the invention are set forth in, or will be apparent to those of ordinary skill in the art from, the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

In a first exemplary embodiment, there may be provided an apparatus for application in horticulture for aiding in the retention of moisture at or near the root systems of individual plants or a group of plants. Such apparatus additionally acts as a nutrient source by way of its own biodegradation. The apparatus may comprise a single composition of human hair formed into a generally planar layer.

Human hair, which is available from barbershop cuttings is not readily weavable and is not readily spun. The length of the hair is generally very short, and is difficult to weave the hair into a textile like sheet or layer, and it is difficult to form the hair into a spun fiber for subsequent processing. Instead, the mat may be formed using a needle punch machine. The needle-punched mat forms a large number of small internal pockets between the interconnected hairs that retain moisture for a longer period of time in addition to that absorbed and retained by the hair itself. These pockets act to retain the moisture in a fixed accessible position for the root system of a plant. Further, the human hair is fully biodegradable and may serves as a passive time-release fertilizer providing nitrogen to the soil in which the mat is placed.

In a second alternative embodiment, there may be provided a generally planar mat comprised solely of animal hair. As discussed above, the mat may be formed using a needle punch machine. The mat may serve to retain moisture for a longer period of time than typical plant watering techniques. Such techniques, generally pouring water into the plant pot, allows for accelerated water loss from the plant due to drainage through the plant's soil and evaporation. Additionally, the mat may be biodegradable and may serve as a passive time-release fertilizer providing for the nutritional needs of the plant with which it is associated.

In a third alternative embodiment, there may be provided a generally planar mat comprised of a combination of human hair, animal hair and/or another or other natural, biodegradable fibers. Such fibers may include, but are not limited to, coconut, seaweed, kelp, cotton and peat moss. As in the above-described alternative embodiments, the generally planar mat may serve to both retain moisture for use by the root system of a plant or group of plants and as a passive source of nutrients by way of its own biodegradation.

Generally, all of the above-described embodiments may be needle-punched to a backing such as burlap or other biodegradable material for use in protecting various trees, bushes and grasses during transportation to new locations. Further, all of such generally planar mats may be of any size and shape for various uses with various sized flora from small potted plants to large trees or even as an underlayment for turf and sod.

The present invention may additionally serve several positive ecological functions: First, larger sized variations of the generally planar mats described above may be rolled and staked into place along hillsides and in areas lacking vegetation to act as an erosion control device. The density of the needle punched hair and fibers serve to prevent the soil from washing away just as it retains the soil in a hanging plant without a pot. Similarly, the present invention may be used to retain a ground covering in place. One such example of this function is the retention of sand within bunkers on golf courses. The present invention may be used as an underlayment to aid in preventing the sand from washing out of heavily angled bunkers.

Further still, such apparatus may be used as an active fertilization source. As nutrients found in the soil begin leaching downward, the present invention traps them within the needle punched hairs and fibers for access by the root system of the plant with which the mat is associated. Further, as the plant seeks to have the moisture, contained in and around the mat, transferred up and into the plant itself, the moisture carries with it certain portions of the trapped nutrients.

Similarly, the present invention is capable of capturing and absorbing any leaching pesticides from the soil. This ability enables the present invention to prevent the unnecessary runoff of pesticides into underground water tables.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a plan view of one embodiment of the apparatus in accordance with the present invention;

FIG. 2 is a perspective view of one embodiment of the present invention acting as a liner for a hanging plant pot;

FIG. 3 is a side view of an embodiment of the present invention for use with landscaping and lawn maintenance; and

FIG. 4 is a perspective view of an alternative embodiment of the present invention in use as an erosion control device.

Repeat use of reference characters throughout the present specification and appended drawings is intended to represent the same or analogous features or elements of the invention.

### DETAILED DESCRIPTION OF THE PREFERRED EMBODIMENTS

Reference will now be made in detail to presently preferred embodiments of the invention, examples of which are filly represented in the accompanying drawings. Such examples are provided by way of an explanation of the invention, not limitation thereof. In fact, it will be apparent to those skilled in the art that various modifications and variations can be made in the present invention, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present invention cover such modifications and variations as come within the scope of the present features and their equivalents.

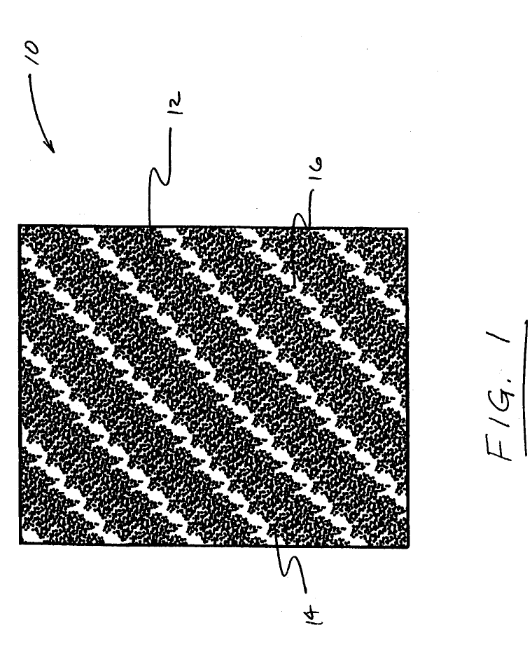

As disclosed above, the present invention is particularly concerned with a dual-use horticultural tool for aiding the proliferation of flora. In a preferred embodiment of the present invention and as best seen in FIG. 1, a generally planar layered mat 10 may be provided. Human hair 12, animal hair 14 and/or a single type or combination of natural fibers 16, such as but not limited to coconut, seaweed, kelp, cotton and peat moss, may be needle punched together to form such mat 10.

The interconnected hairs/fibers 12, 14 and 16 within the mat 10 serve to create numerous small pockets within the mat 10 similarly to that of a sponge which can retain moisture for later use by the plant with which the mat 10 is associated. The mat 10 may be used as a liner for the pot in which a plant is to be retained. Additionally, the mat 10 may serve as both an active and a passive nutrient source for the plant either by releasing captured nutrients leaching through the soil or by biodegrading into its baser chemical compounds. Multi-layer mats 10 may be formed by needle punching two or more mats 10 together.

FIG. 1 shows the present invention formed into a generally rectangular mat 10. The present invention is not limited merely too generally rectangular mats 10. Instead the present invention may be formed into any number of shapes including circular, triangular and elliptical shapes so as to better fit into various plant containers. Generally, however, the mat 10 should be generally planer so as to better serve as a liner in hanging plant pots and within prepared planting holes in the ground or even under original sod plantings.

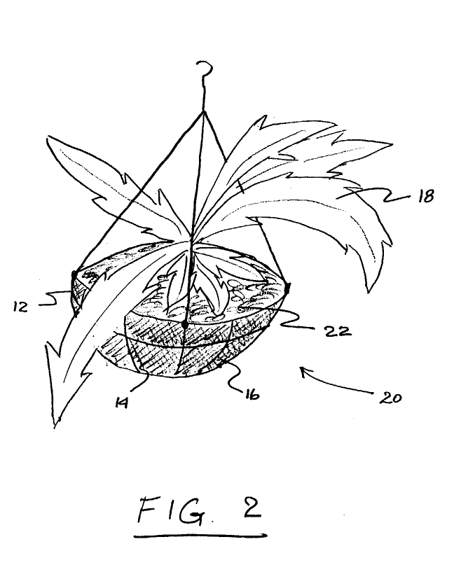

FIG. 2 shows the present invention in use as a hanging plant liner 20. The combination of both human 12 and animal hair 14 with a single or combination of natural fibers 16 allows the present invention to absorb and maintain the vast majority of water normally given a plant 18 during a watering. As such, the present invention provides a constant source of moisture at or near the root system 22 of a plant 18 or a group of plants. Further, the density of the mat 20 itself is sufficient to retain the soil within a hanging plant 18 without the need for a container.

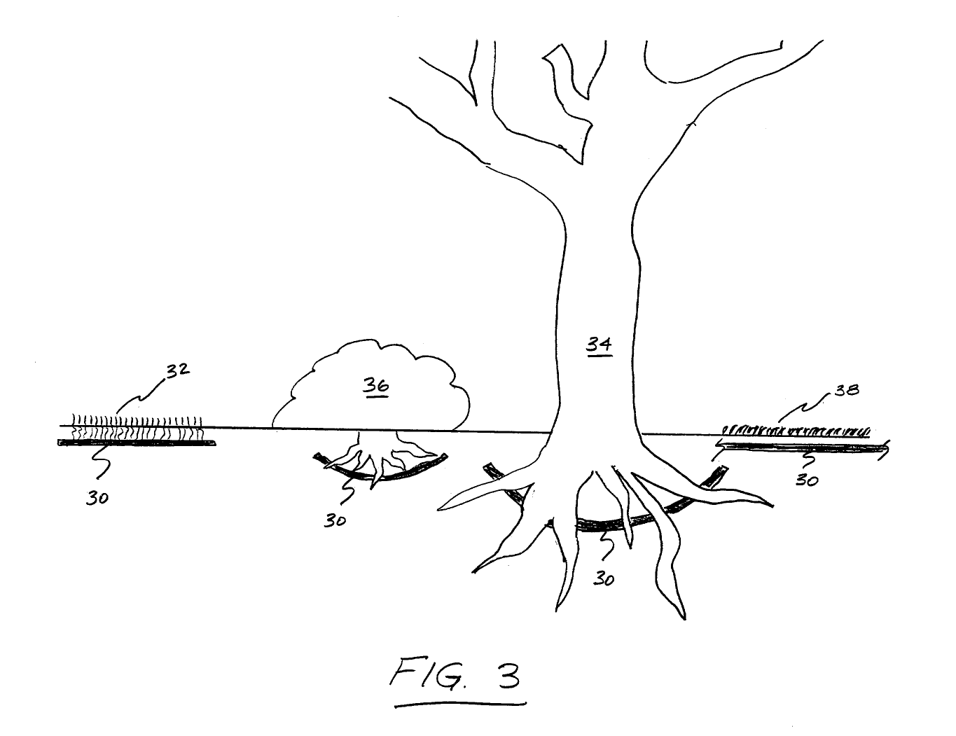

As seen in FIG. 3, the present invention may be used as an underlayment 30 for landscaping elements such as sod 32, trees 34 or bushes 36. In such an application the underlayment 30 may generally be larger than the traditional indoor potted plant sized variation of the present invention. While the underlayment 30 may be sized to line a hole for planting a tree 34, it may also be provided in larger rolls for use under sod 32. As with the smaller plant pot liners, the larger landscaping underlayment 30 act to retain moisture creating a perched water table for serving such landscaping elements and serve as a time-released fertilization source for landscaping elements 32, 34 and 36. When used with sod 32, the underlayment 30 additionally serves to enhance root growth and allow for a lawn 38 to establish itself quicker.

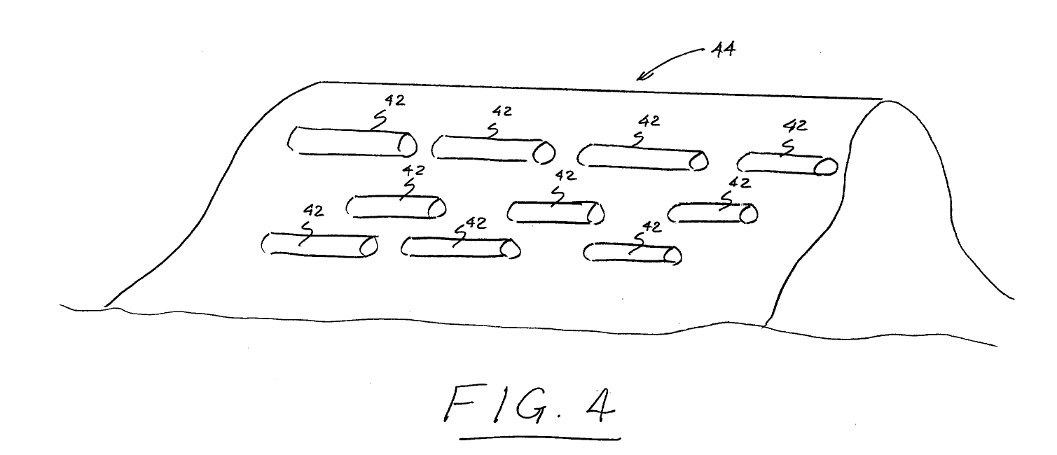

The present invention, as shown in FIG. 4, may also be used for additional purposes—erosion control and seed germination. As with hanging plants without pots, the density of the needle punched hair and fibers allows the present invention to retain soil from washing away on hillsides and exposed ground areas that lack vegetation. Generally, this may be achieved by forming a larger version of the generally planar mat 10, similar to that used as an underlayment 30 for sod 32, into a roll 42 that may then be staked in place along a hillside 44 or near an uncovered area.

As mentioned above, the present invention may also serve as an ideal location for seed germination. All plants require higher amount of moisture to induce the germination of their seeds. The present invention, in any of its various forms, serves to ensure such an ideal environment for a seed or seedling. In addition, the present invention may remain with the seedling after germination as a long-term source of nutrients and a constant source of moisture to ensure accelerated growth.

The method of using the present invention is as follows. The apparatus may be used as a liner for hanging pot plants or as an underlayment for potted or in-ground plants, trees, bushes or grasses. A user prepares the container, either a hanging plant wire mesh container, a hanging pot, a flowerpot or a hole in the Earth by lining the bottom of the container with the present invention. The plant, tree, or bush may then be placed into the container and fill dirt and any desired amendments may be added. All new plantings should be watered and the present invention aids in this function as discussed above by retaining a greater percentage of the moisture at or near the root system of the newly re-located plant.

Although a preferred embodiment of the invention has been described using specific terms and devices, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged both in whole or in part. Therefore, the spirit and scope of the appended claims should not be limited to the description of the preferred version contained herein.

What is claimed is:

1. A multi-use horticultural device, comprising:
a plurality of natural fibers; and
wherein said plurality of natural fibers are needle-punched together to form a generally planar mat.

2. A device as set forth in claim 1, wherein said generally planar mat absorbs moisture when exposed thereto.

3. A device as set forth in claim 2, wherein said absorption of water includes the direct absorption of water by the plurality of natural fibers.

4. A device as set forth in claim 3, wherein said generally planar mat contains numerous cavities between the needle-punched plurality of natural fibers, and wherein said cavities also act to retain moisture therein when exposed thereto.

5. A device as set forth in claim 1, wherein said plurality of natural fibers includes any single one or combination of the group comprising human hair, animal hair, coconut fiber, cotton, seaweed, kelp, and peat moss.

6. A device as set forth in claim 1, wherein said generally planar mat is completely biodegradable.

7. A device as set forth in claim 6, wherein biodegradation of said generally planar mat serves to provide nutrients to any plant with which said mat is associated.

8. A method of using a moisture retention device, comprising the steps of:
preparing a planting location for receipt of a plant, tree, bush or grass;
lining said planting location with said moisture retention device;
inserting said plant, tree, bush or grass into said planting location;
covering the root system of said plant, tree, bush or grass with soil;
watering said plant, tree, bush or grass.

9. The method of claim 8, wherein said moisture retention device comprises:
a plurality of natural fibers, wherein said plurality of natural fibers are needle-punched together to form a generally planar mat.

10. The method of claim 9, wherein said generally planar mat contains numerous cavities between the needle-punched plurality of natural fibers, and wherein said cavities also act to retain moisture therein when exposed thereto.

11. The method of claim 9, wherein said plurality of natural fibers include any single one or combination of a group comprising human hair, animal hair and coconut fiber.

12. The method of claim 10, wherein said generally planar mat is completely biodegradable.

13. The method of claim 12, wherein biodegradation of said generally planar mat serves to fertilize said plant, tree, bush or grass with which it is associated.
